(19) United States
(12) Patent Application Publication
(10) Pub. No.: US 2017/0265005 A1
(43) Pub. Date: Sep. 14, 2017

(54) MICROPHONE CAPSULE WITH ODD NUMBER OF SIDES

(71) Applicant: Baltic Latvian Universal Electronics, LLC, Westlake Village, CA (US)

(72) Inventors: Daniel C. Wiggins, Port Hueneme, CA (US); James Patrick Butler, Los Angeles, CA (US); Jonathan Oswaks, Thousand Oaks, CA (US)

(21) Appl. No.: 15/064,336

(22) Filed: Mar. 8, 2016

(51) Int. Cl. H04R 7/02; H04R 19/00

(52) U.S. Cl. CPC H04R 7/02; H04R 19/005

(57) ABSTRACT

There is disclosed a microphone and a microphone capsule including the microphone. The microphone includes a diaphragm having a perimeter shaped as a polygon with an odd number of sides.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

Field

This disclosure relates to microphones, and specifically to high performance microphone systems with improved total harmonic distortion.

Description of the Related Art

A microphone is a transducer for converting acoustic waves to electrical signals. Typical microphones include a diaphragm or other flexible element that moves in response to incident acoustic waves. The motion of the diaphragm is then sensed by an electrical circuit to create an electrical signal.

A diaphragm is a thin flexible disk that vibrates when struck by sound waves. A diaphragm may be made of a metal material, or a dielectric material with a metallic coating. Within this patent, the “shape” of a diaphragm refers to the shape of the perimeter of the thin flexible disc. For example, a circular diaphragm has a perimeter shaped as a circle, and a polygonal diaphragm has a perimeter shaped as a polygon.

For example, in an electrostatic microphone, also commonly called a condenser microphone, a fixed plate and the diaphragm collectively form a parallel plate capacitor. The motion of the diaphragm in response to incident acoustic waves varies the capacitance of the parallel plate capacitor. A polarizing voltage must be applied via a high value load resistor to charge or polarize the parallel plate capacitor. Variations in the capacitance in response to incident acoustic waves may then be sensed as modulation of the voltage across the capacitor.

An electret microphone is a particular type of electrostatic microphone in which at least one of the fixed plate and the diaphragm include a permanently charged dielectric layer. The presence of the permanent charge obviates the need for a polarizing voltage source to charge the parallel plate capacitor. Electret microphones are used in many applications, from high-quality sound recording to built-in microphones in consumer electronic devices. Nearly all cell-phones, computers, and headsets incorporate electret microphones.

Electrostatic microphones are commonly produced in the form of a “capsule” containing the parallel-plate capacitor microphone and a circuit or preamplifier to transform the high impedance of the parallel-plate capacitor microphone to a lower impedance value. As shown in FIG. 1A, an electrostatic microphone capsule 100 may include a microphone 110 and a field-effect transistor (FET) Q having gate, source, and drain contacts. A high value (for example, greater than 1 Gigohm) resistor R between the gate and drain contacts may be provided or intrinsic to the FET Q.

The microphone 110 includes a diaphragm 115 and a fixed plate 120. One side of the microphone 110 (either the diaphragm 115 or the fixed plate 120) is electrically connected to the gate of the FET Q. In the exemplary microphone capsule 100 shown in FIG. 1A, the fixed plate 120 of the microphone 110 is connected to the gate of the FET Q. In “two-terminal” electret microphone capsules, which do not require an external bias voltage for the microphone, the second side of the microphone 110 may be electrically connected to the source of the FET Q and thus the second terminal T2. In “three-terminal” electret capsules and other electrostatic microphone capsules, the second side of the microphone 110 (the other of the diaphragm 115 or the fixed plate 120) may be electrically connected to a third terminal T3, as shown in FIG. 1A. The third terminal T3 may be connected to a bias voltage external to the microphone capsule 100.

FIG. 1B shows a representative electrostatic microphone capsule 150, in the form of a cylindrical housing 155 with a circular diaphragm 160 on one circular face and electrical terminals (not visible) on the other circular face. The diaphragm 160 may be protected by a perforated screen or cover (not shown) that admits sound waves while providing mechanical protection to the diaphragm. To the knowledge of the inventors, the diaphragms of electrostatic microphones are universally circular in shape.

However, circular microphone diaphragms have various vibrational resonance modes. FIGS. 2A, 2B, 2C, 2D, and 2E illustrates the five lowest-frequency vibrational resonance modes of a circular diaphragm derived from finite element modeling of the diaphragm. The fine lines visible in each figure are the triangular elements used in the finite element model. Within each figure, lighter areas have the greatest vibration amplitude normal to the resting plane of the diaphragm (i.e. the plane of the figure), and darker areas have smaller excursions. The portion of the diaphragm at the perimeter of each figure is stationary. These vibrational resonances contribute to distortion in the signal produced by the microphone.

### DESCRIPTION OF THE DRAWINGS

FIG. 1A is a schematic diagram of an electrostatic microphone capsule.

FIG. 1B shows a representative electrostatic microphone capsule.

FIGS. 2A, 2B, 2C, 2D, and 2E illustrate vibrational resonance modes of a circular diaphragm.

FIGS. 3A, 3B, 3C, and 3D are plan views of microphone diaphragms having five, seven, nine, and eleven sides, respectively.

FIGS. 4A, 4B, 4C, 4D, and 4E illustrate vibrational resonance modes of a diaphragm having seven sides.

FIG. 5 is a graph of peak amplitude versus frequency for vibrational resonance modes of a circular diaphragm and a diaphragm having seven sides.

FIG. 6 is a graph of microphone sensitivity loss versus the number of sides on a non-circular diaphragm.

FIG. 7 is a graph of microphone sensitivity versus frequency for a circular diaphragm and a diaphragm having seven sides.

FIG. 8 is a graph of microphone total harmonic distortion versus frequency for a circular diaphragm and a diaphragm having seven sides.

FIG. 9 shows a perspective view of a representative capsule from an electrostatic microphone having a diaphragm with seven sides.

Throughout this description, elements appearing in figures are assigned three-digit reference designators, where the most significant digit is the figure number where the element first appears, and the two least significant digits are specific to the element. An element that is not described in conjunction with a figure may be presumed to have the same characteristics and function as a previously-described element having the same reference designator.

### DETAILED DESCRIPTION

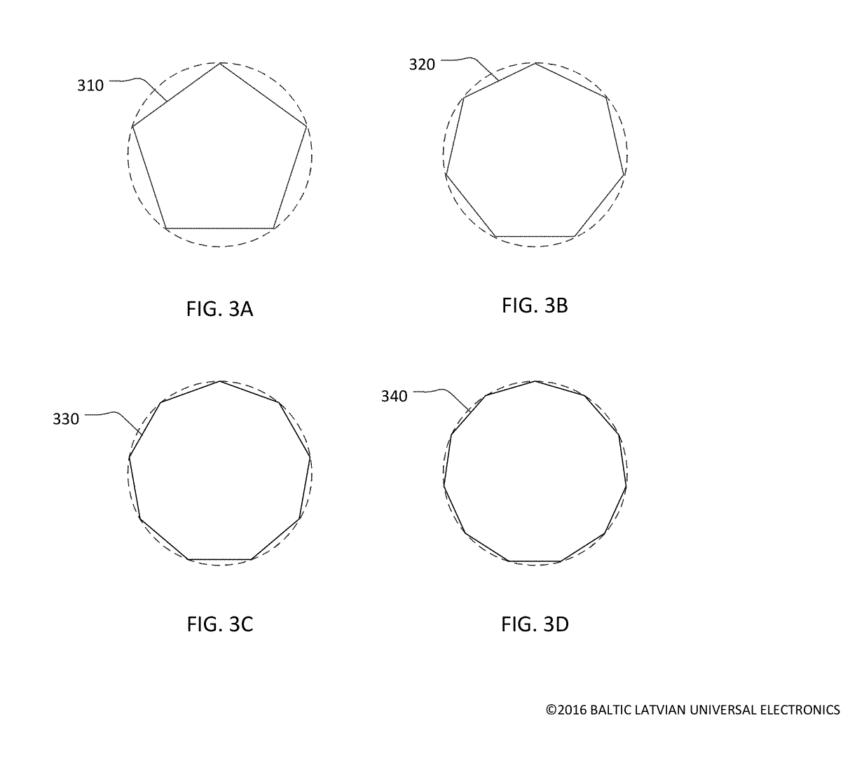

FIG. 3A is a plan view of a diaphragm 310 having five sides. Similarly, FIGS. 3B, 3C, and 3D are plan views of diaphragms 320, 330, and 340 having seven, nine, and eleven sides, respectively. Each of the non-circular diaphragms 310, 320, 330, and 340 is inscribed within the same size circle and each is formed as a regular polygon having five, seven, nine, or eleven equal-length sides. However, a non-circular diaphragm need not necessarily be a regular polygon with equal-length sides. A non-circular diaphragm may be an irregular polygon wherein lengths of at least two sides are not equal.

Subsequent paragraphs will compare the performance of polygonal diaphragms and circular diaphragms. In all cases, a polygonal diaphragm is compared with a circular diaphragm having a diameter of a circle that can be drawn through the vertices of the polygonal diaphragm. Further, all comparisons assume the use of the same diaphragm thickness, the same materials and the same design practices.

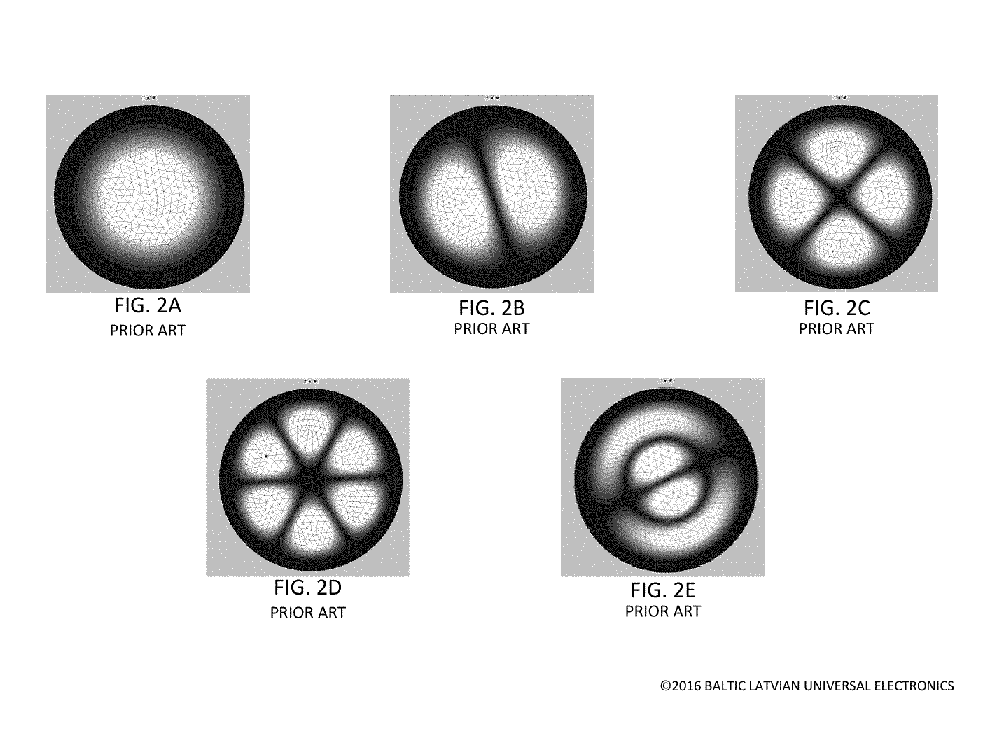

The rationale for selecting diaphragms having an odd number of sides can be understood upon consideration of FIGS. 2B, 2C, 2D, and 2E, which show that at least some of the vibrational resonance modes of a circular diaphragm have an even number of lobes. For example, the vibrational resonance mode illustrated in FIG. 2C will exist in a square diaphragm, but might be suppressed or attenuated if the diaphragm has three or five sides. Similarly, the vibrational resonance mode illustrate in FIG. 2D will exist in a hexagonal diaphragm, but might be attenuated or suppressed if the diaphragm has five or seven sides.

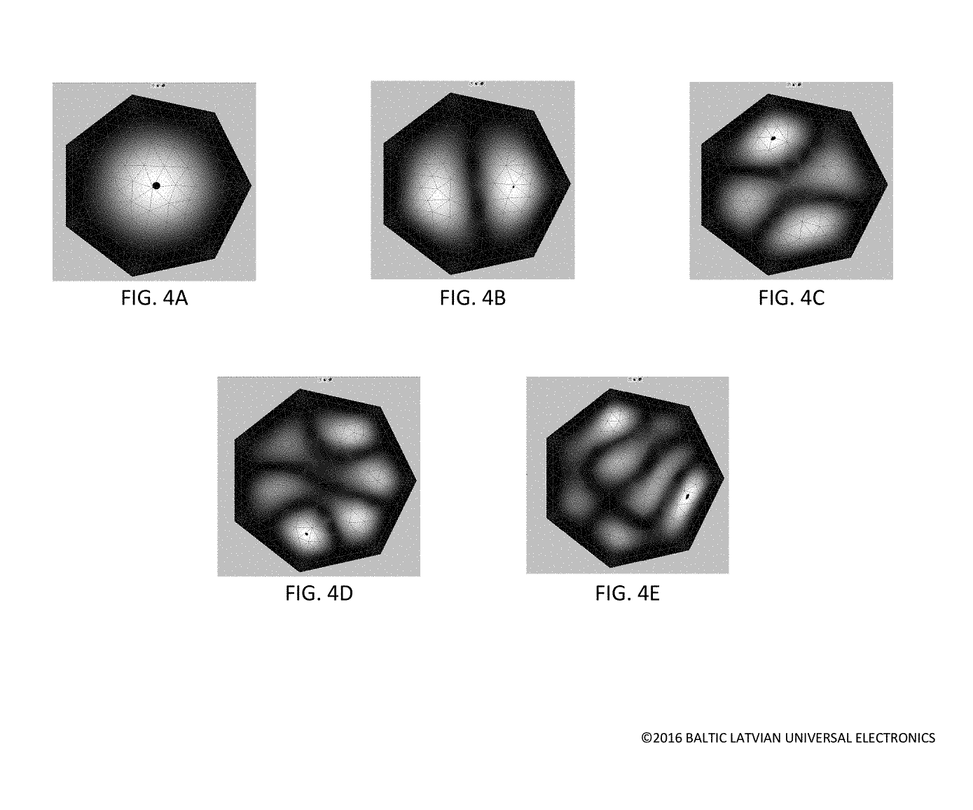

Finite element modeling of the vibrational modes of diaphragms having odd numbers of sides confirmed that the amplitudes of vibrational resonances are reduced. Further, the results of the modeling indicated that the frequencies of various vibrational resonance modes are increased. FIGS. 4A, 4B, 4C, 4D, and 4E illustrates the five lowest-frequency vibrational resonance modes of a regular heptagon (seven sides) diaphragm derived from finite element modeling of the diaphragm. The fine lines visible in each figure are the triangular elements used in the finite element models. Within each figure, lighter areas have the greatest vibration amplitude normal to the resting plane of the diaphragm (i.e. the plane of the figure), and darker areas have smaller excursions. The portion of the diaphragm at the perimeter of the heptagon is stationary. Comparison of FIGS. 4A, 4B, 4C, 4D, and 4E and FIGS. 2A, 2B, 2C, 2D, and 2E shows that the vibrational resonance modes of the seven-sided diaphragm have lower amplitude and lack symmetry compared to the vibrational resonance modes of the circular diaphragm.

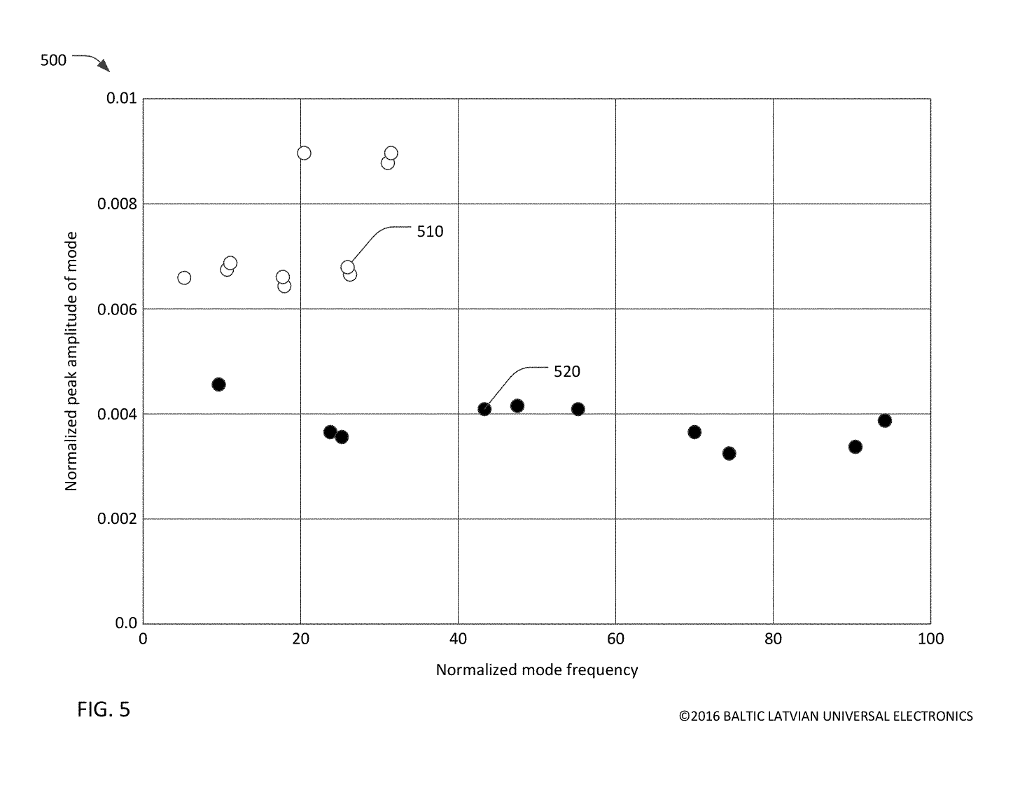

FIG. 5 is a graph 500 showing the normalized resonance frequencies and amplitudes of the ten lowest-frequency vibrational resonance modes of a circular diaphragm (open circles 510) and the resonance frequencies and amplitudes of the ten lowest-frequency vibrational resonance modes of a regular heptagon diaphragm (filled circles 520), as determined from finite-element modeling. The absolute frequency and amplitude of a diaphragm vibrational resonance mode depends on a number of factors including the diaphragm diameter and thickness, and characteristics (density, elastic constant) of the material used for the diaphragm. To provide a basis for comparison, the finite element models assumed that the heptagonal diaphragm could be inscribed within the circumference of the circular diaphragm and that the thickness, material, and mounting method of both diaphragms are the same.

As shown in FIG. 5, the average amplitude of the vibrational resonance modes of the heptagon diaphragm (filled circles 520) is about half of the average amplitude of the vibrational resonance modes of the circular diaphragm (open circles 510). Further, the vibrational resonance modes of the heptagon diaphragm are distributed over a much wider frequency range than the vibrational resonance modes of the circular diaphragm. Compared to a circular diaphragm, a heptagonal diaphragm has both fewer and lower amplitude vibrational resonances within the audible frequency spectrum (i.e. 20 Hz to 20,000 Hz).

The data presented in FIG. 5 is specific to a diaphragm having seven sides. It is expected that diaphragms with three or five sides would be even more effective at suppressing vibrational resonance modes. Polygonal diaphragms with more than seven sides, such as nine sides or eleven sides, will also exhibit reduced vibrational resonance amplitude compared to circular diaphragms. As the number of sides of a polygon is increased, the polygon becomes an ever closer approximation to a circle. Thus increasing the number of sides of a diaphragm beyond eleven may result in reduced improvement compared to a circular diaphragm.

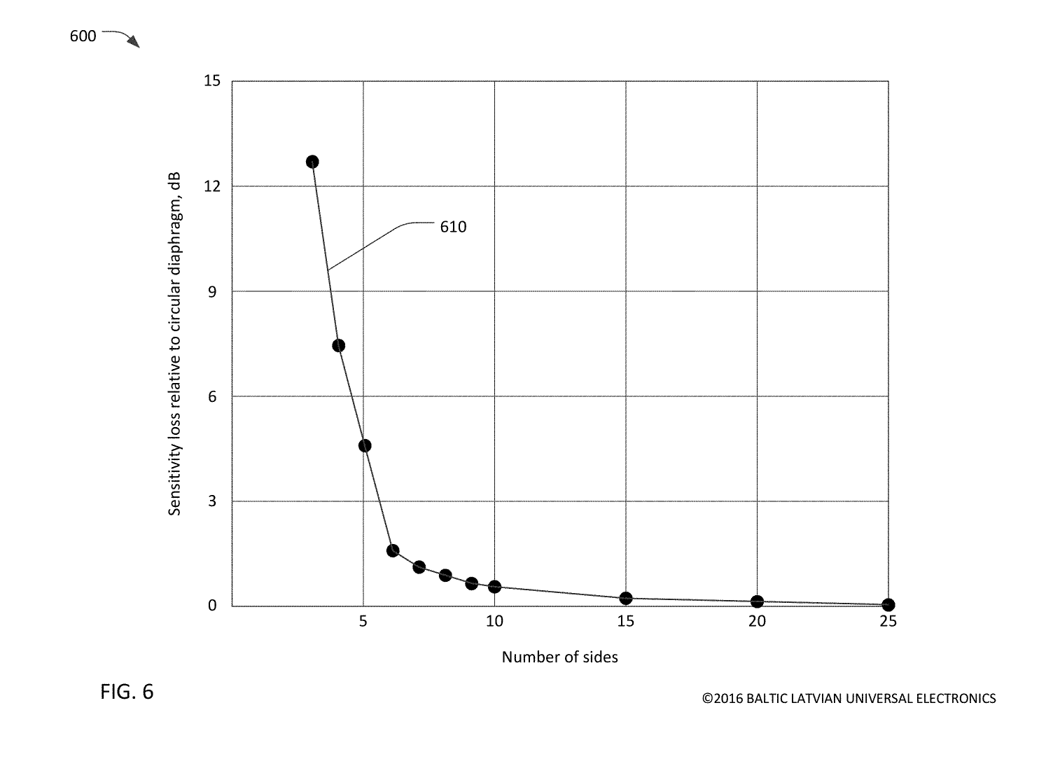

Substituting a polygonal diaphragm for a circular diaphragm is not without cost. The surface area of a polygonal diaphragm is inherently smaller than the surface area of a circle drawn though the vertices of the polygon. Thus a polygonal diaphragm will intercept less sound pressure than a circular diaphragm having the diameter of a circle drawn though the vertices of the polygon. FIG. 6 is a graph 600 of a sensitivity loss of a regular polygonal diaphragm relative to a circular diaphragm as a function of the number of sides of the polygonal diaphragm. The sensitivity loss is substantial for triangular and pentagonal diaphragms (3 and 5 sides, respectively). The sensitivity loss for polygonal diaphragms having seven or more sides is about 1 dB or less. Polygonal diaphragms having seven, nine, and eleven sides may provide a reasonable compromise between sensitivity loss and reduction of vibrational resonances.

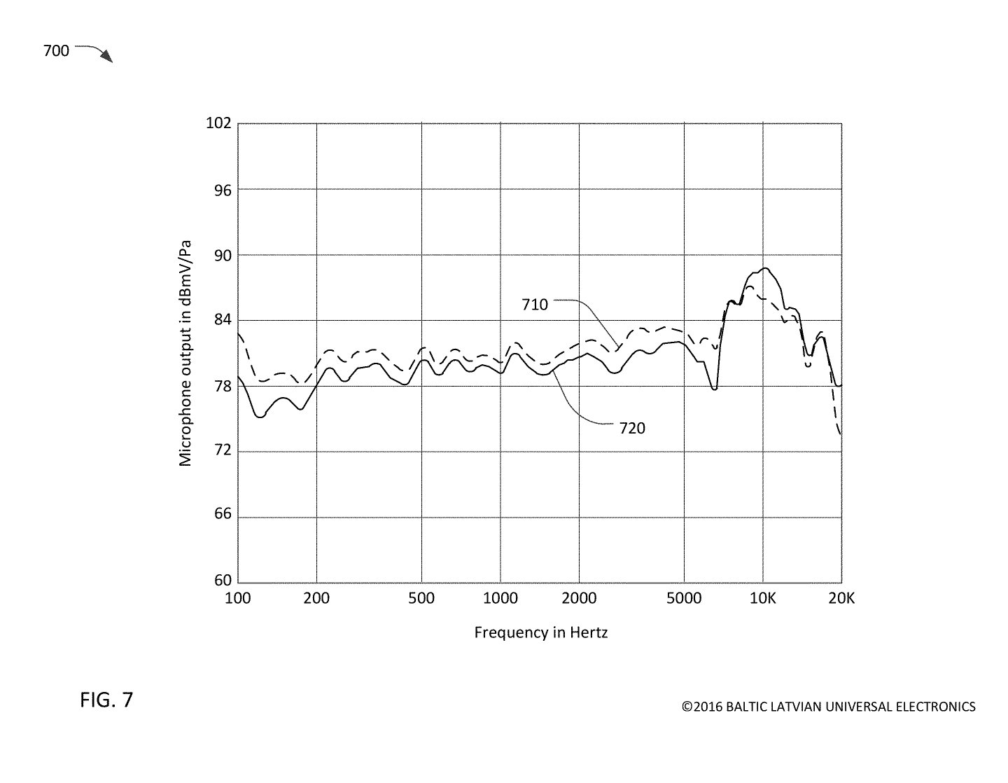

FIG. 7 is a graph 700 comparing the measured frequency response of a microphone having a regular heptagonal diaphragm and a microphone with a circular diaphragm. Specifically, dashed line 710 is the frequency response of the microphone with a circular diaphragm and the solid line 720 is the frequency response of the microphone with a heptagonal diaphragm. The horizontal axis of the graph 700 represents frequency in Hertz, and the vertical axis represents microphone output in millivolts (mV) per Pascal (Pa) of sound pressure on a logarithmic (dB) scale. The microphone with the heptagonal diaphragm (solid line 720) has about 1 dB lower sensitivity than the microphone with a circular diaphragm (dashed line), in agreement with FIG. 6.

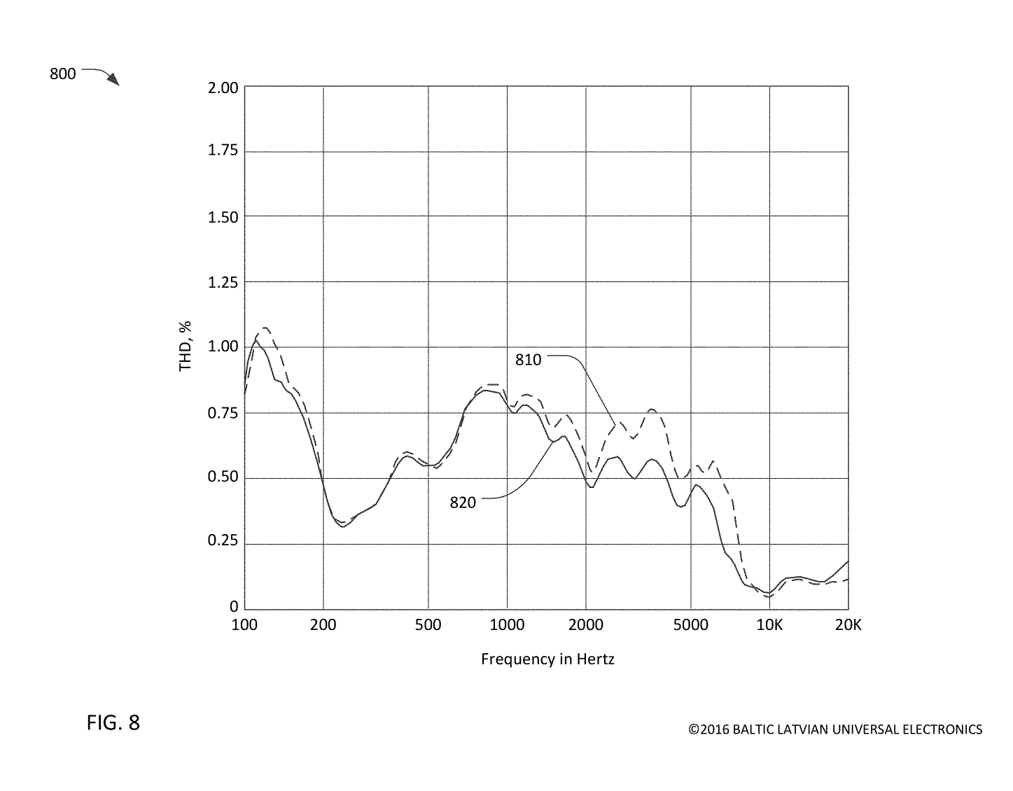

FIG. 8 is a graph 800 comparing the measured total harmonic distortion of a microphone having a regular heptagonal diaphragm and a microphone with a circular diaphragm. Specifically, dashed line 810 is the total harmonic distortion of the microphone with a circular diaphragm and the solid line 820 is the total harmonic distortion of the microphone with a heptagonal diaphragm. The microphone with the heptagonal diaphragm has lower total harmonic distortion over much of the audible frequency range. The lower distortion of the microphone with the heptagonal diaphragm is both measurable and audible when sounds captured by the microphone are replayed.

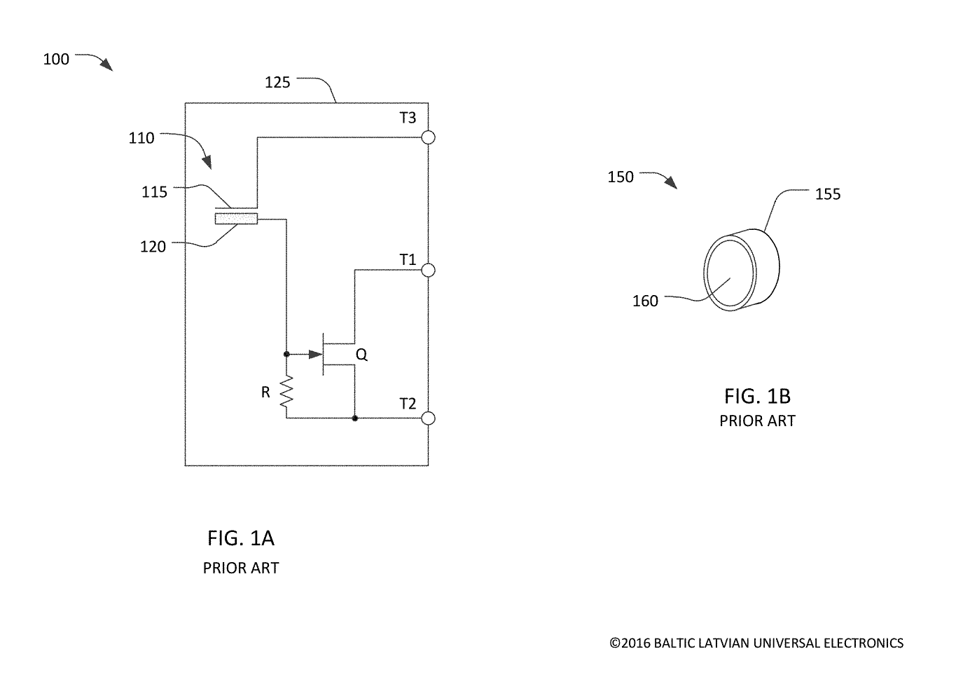

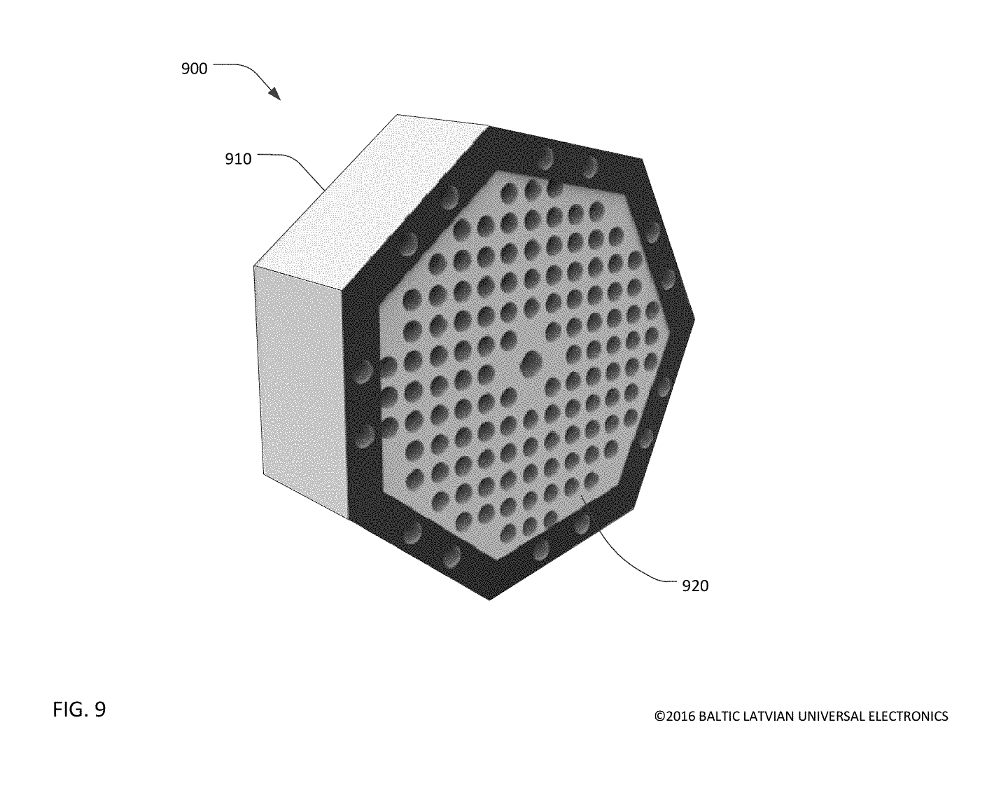

FIG. 9 is a perspective view of an exemplary microphone capsule 900 incorporating a heptagonal diaphragm. The microphone capsule 900 includes a housing 910 and a perforated cover 920. The diaphragm (not visible) is disposed behind the perforated cover 920 that provides mechanical protection while allowing sound waves to reach the diaphragm. The microphone capsule 900 may incorporate a field effect transistor, as shown in FIG. 1A. Electrical terminals may be located on the side of the microphone capsule 900 facing away from the viewer. A microphone having a polygonal diaphragm need not necessarily be packaged in a housing having a polygonal shape as shown in FIG. 9. The housing 910 may, for example, have a cylindrical or other shape.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A microphone, comprising:
a diaphragm, a perimeter of the diaphragm shaped as a polygon with an odd number of sides, the perimeter of the diaphragm having at least five sides.

2. (canceled)

3. The microphone of claim 1, wherein the number of sides of the perimeter of the diaphragm is selected from seven, nine, and eleven sides.

4. The microphone of claim 1, wherein the perimeter of the diaphragm has seven sides.

5. The microphone of claim 1, wherein the perimeter of the diaphragm is a regular heptagon.

6. The microphone of claim 1, wherein the perimeter of the diaphragm is a regular polygon wherein the lengths of all sides are equal.

7. The microphone of claim 1, wherein the perimeter of the diaphragm is an irregular polygon wherein the lengths of at least two of the sides are unequal.

8. A microphone capsule, comprising:
a housing;
a microphone disposed within the housing, the microphone comprising a diaphragm having a perimeter shaped as a polygon with an odd number of sides, the perimeter of the diaphragm having at least five sides; and
a field effect transistor disposed within the housing, a gate of the field effect transistor connected to the microphone.

9. (canceled)

10. The microphone capsule of claim 8, wherein the number of sides of the perimeter of the diaphragm is selected from seven, nine, and eleven sides.

11. The microphone capsule of claim 8, wherein the perimeter of the diaphragm has seven sides.

12. The microphone capsule of claim 8, wherein the perimeter of the diaphragm is a regular heptagon.

13. The microphone capsule of claim 8, wherein the perimeter of the diaphragm is a regular polygon wherein the lengths of all sides are equal.

14. The microphone capsule of claim 8, wherein the perimeter of the diaphragm is an irregular polygon wherein the lengths of at least two of the sides are unequal.
